(19) United States
(12) Patent Application Publication
(10) Pub. No.: US 2015/0354639 A1
(43) Pub. Date: Dec. 10, 2015

(54) Hydraulic Control Device

(71) Applicant: AISIN AW CO., LTD., Anjo-shi, Aichi-ken (JP)

(72) Inventors: Kazunori ISHIKAWA, Toyota (JP); Kazuyuki NODA, Handa (JP); Kenichi TSUCHIDA, Nishio (JP); Koji MAKINO, Okazaki (JP); Keiji SUZUKI, Anjo (JP); Yoshimitsu HYODO, Nishio (JP)

(73) Assignee: AISIN AW CO., LTD., Anjo-shi, Aichi-ken (JP)

(21) Appl. No.: 14/764,715

(22) PCT Filed: Mar. 20, 2014
(86) PCT No.: PCT/JP2014/057735

§ 371 Date: Jul. 30, 2015

(30) Foreign Application Priority Data
Mar. 29, 2013 (JP) 2013-072483

(51) Int. Cl. F16D 48/02; F16D 65/14

(52) U.S. Cl. CPC F16D 25/14; F16D 65/14

(57) ABSTRACT

A hydraulic control device that includes a solenoid valve that includes an input port, an output port that communicates with the hydraulic engagement element via an oil passage, and a feedback port that communicates with the output port via the oil passage, the solenoid valve regulating a pressure of working oil input from the input port to output the regulated pressure from the output port to the oil passage, a part of the output working oil being input to the feedback port; and a hydraulic damper that damps pulsation of the hydraulic pressure output from the output port to the oil passage, wherein: the oil passage is provided with an orifice mechanism that reduces a flow rate of the working oil; and the hydraulic damper communicates with the oil passage on a side of the output port and the feedback port with respect to the orifice mechanism.

### BACKGROUND

The present disclosure relates to a hydraulic control device, and particularly to a hydraulic control device that controls an engagement hydraulic pressure to be supplied to a hydraulic engagement element.

Hitherto, there has been proposed a hydraulic control device of this type that includes: a liner solenoid valve that regulates a hydraulic pressure supplied to an input port to output the regulated hydraulic pressure from an output port; a switching valve that switches between establishment and blockage of communication between an output port oil passage connected to the output port of the liner solenoid valve and a clutch oil passage connected to a clutch; and a hydraulic damper connected to the clutch oil passage on the side of the clutch with respect to an orifice (see JP 2011-112064 A, for example). The device suppresses fluctuations (pulsation) of a hydraulic pressure supplied to and discharged from the clutch through the action of the hydraulic damper.

### SUMMARY

In the hydraulic control device discussed above, the hydraulic damper is connected to the clutch oil passage on the side of the clutch with respect to the orifice (the hydraulic damper is disposed in proximity to the clutch). Thus, the hydraulic pressure in a feedback chamber (an oil chamber to which working oil is input via a feedback port) of a solenoid valve having an input port, an output port, and the feedback port tends to be high, which reduces the output response of the solenoid valve. Therefore, in order to secure (enhance) the output response, it is necessary to make the solenoid valve larger in physical size. If the hydraulic damper is connected to the clutch oil passage on the side of the clutch with respect to the orifice, meanwhile, fluctuations (pulsation) of the hydraulic pressure output from the liner solenoid valve to be supplied to the clutch may not be sufficiently suppressed.

The hydraulic control device according to an exemplary aspect of the present disclosure proposes a configuration that can improve the output response without making a solenoid valve larger in physical size and suppress fluctuations (pulsation) of an engagement hydraulic pressure to be supplied from the solenoid valve to a hydraulic engagement element.

In order to achieve the foregoing, according to an exemplary aspect, the hydraulic control device that controls an engagement hydraulic pressure to be supplied to a hydraulic engagement element, includes a solenoid valve that includes an input port, an output port that communicates with the hydraulic engagement element via an oil passage, and a feedback port that communicates with the output port via the oil passage, the solenoid valve regulating a pressure of working oil input from the input port to output the regulated pressure from the output port to the oil passage, a part of the output working oil being input to the feedback port; and a hydraulic damper that damps pulsation of the hydraulic pressure output from the output port to the oil passage, wherein: the oil passage is provided with an orifice mechanism that reduces a flow rate of the working oil; and the hydraulic damper communicates with the oil passage on a side of the output port and the feedback port with respect to the orifice mechanism.

In the hydraulic control device according to an exemplary aspect of the present disclosure, the oil passage which communicates between the output port and the feedback port and the hydraulic engagement element is provided with the orifice mechanism which reduces the flow rate of working oil, and the hydraulic damper which damps pulsation of the hydraulic pressure output from the output port to the oil passage communicates with the oil passage on the side of the output port and the feedback port with respect to the orifice mechanism. With this configuration, it is possible to suppress a rise in hydraulic pressure in a feedback chamber (an oil chamber to which working oil is input via the feedback port) of the solenoid valve compared to a configuration in which the hydraulic damper communicates with the oil passage on the side of the hydraulic engagement element with respect to the orifice mechanism, which improves the output response of the solenoid valve without making the solenoid valve larger in physical size. In addition, it is possible to suppress fluctuations (pulsation) of the hydraulic pressure output from the output port to the oil passage compared to a configuration in which the hydraulic damper communicates with the oil passage on the side of the hydraulic engagement element with respect to the orifice mechanism.

In the hydraulic control device according to an exemplary aspect of the present disclosure, the hydraulic damper may communicate with the oil passage such that a distance from the hydraulic damper to the output port and the feedback port is shorter than a distance from the hydraulic damper to a hydraulic pressure chamber for engagement and disengagement of the hydraulic engagement element. With this configuration, it is possible to effectively suppress fluctuations (pulsation) of the engagement hydraulic pressure supplied from the solenoid valve to the hydraulic engagement element.

### BRIEF DESCRIPTION OF THE DRAWINGS

FIG. 1 illustrates a schematic configuration of an automobile incorporating a power transfer device including a hydraulic control device according to the present disclosure.

FIG. 2 illustrates a schematic configuration of the power transfer device.

FIG. 3 is an operation table illustrating the relationship between each shift speed of the automatic transmission and the respective operating states of clutches and brakes.

FIG. 4 is a system diagram illustrating the hydraulic control device.

FIG. 5 is a system diagram of a part of the hydraulic control device.

FIG. 6 is a system diagram of a part of a hydraulic control device according to a comparative example.

FIG. 7 illustrates an example of temporal variations in a hydraulic pressure command value for a first linear solenoid valve at the time when a clutch is brought from a disengaged state to an engaged state.

### DETAILED DESCRIPTION OF THE EMBODIMENTS

Now, a mode for carrying out the present disclosure will be described by way of an embodiment.

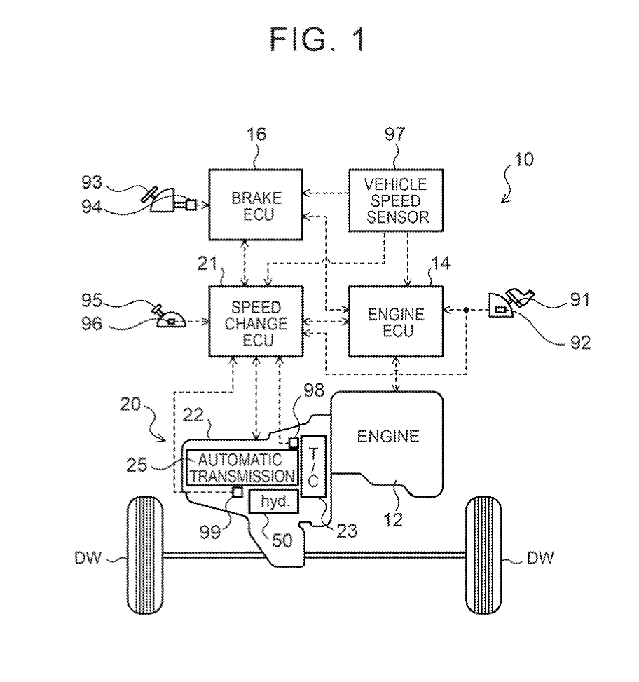

FIG. 1 illustrates a schematic configuration of an automobile 10 incorporating a power transfer device 20 including a hydraulic control device 50 according to the present disclosure. The automobile 10 illustrated in the drawing includes: an engine (internal combustion engine) 12 that serves as a motor that outputs power through explosive combustion of a mixture of a hydrocarbon fuel, such as gasoline and light oil, and air; an engine electronic control unit (hereinafter referred to as an “engine ECU”) 14 that controls the engine 12; a brake electronic control unit (hereinafter referred to as a “brake ECU”) 16 that controls an electronically controlled hydraulic brake unit (not illustrated); a power transfer device 20 connected to the engine 12 to transfer power from the engine 12 to left and right drive wheels DW; and so forth. The power transfer device 20 includes a transmission case 22, a fluid transmission device 23, an automatic transmission 25, the hydraulic control device 50, a speed change electronic control unit (hereinafter referred to as a “speed change ECU”) 21 that controls such components and that serves as the control device according to the present disclosure, and so forth.

The engine ECU 14 is structured as a microcomputer including a CPU (not illustrated) as a main component, and has a ROM that stores various programs, a RAM that temporarily stores data, input and output ports and a communication port (none of which is illustrated), and so forth besides the CPU. As illustrated in FIG. 1, the engine ECU 14 receives inputs such as an accelerator operation amount Acc from an accelerator pedal position sensor 92 that detects the amount of depression (amount of operation) of an accelerator pedal 91, a vehicle speed V from a vehicle speed sensor 97, signals from various sensors such as a crankshaft position sensor (not illustrated) that detects the rotational position of a crankshaft, and signals from the brake ECU 16 and the speed change ECU 21. The engine ECU 14 controls an electronically controlled throttle valve, a fuel injection valve, an ignition plug, and so forth (none of which is illustrated) on the basis of the received signals. Further, the engine ECU 14 calculates a rotational speed Ne of the engine 12 on the basis of the rotational position of the crankshaft detected by the crankshaft position sensor. In addition, the engine ECU 14 is configured to execute idle stop control (automatic stop/start control) in which operation of the engine 12 is stopped normally when the engine 12 is brought into idle operation or the like as the automobile 10 becomes stationary and in which the engine 12 is restarted in response to a request to start the automobile 10 made by depressing the accelerator pedal 91.

The brake ECU 16 is also structured as a microcomputer including a CPU (not illustrated) as a main component, and has a ROM that stores various programs, a RAM that temporarily stores data, input and output ports and a communication port (none of which is illustrated), and so forth besides the CPU. As illustrated in FIG. 1, the brake ECU 16 receives inputs such as a master cylinder pressure Pmc detected by a master cylinder pressure sensor 94 when a brake pedal 93 is depressed, the vehicle speed V from the vehicle speed sensor 97, signals from various sensors (not illustrated), and signals from the engine ECU 14 and the speed change ECU 21. The brake ECU 16 controls a brake actuator (hydraulic actuator) (not illustrated) etc. on the basis of the received signals.

The speed change ECU 21 is also structured as a microcomputer including a CPU (not illustrated) as a main component, and includes a ROM that stores various programs, a RAM that temporarily stores data, input and output ports and a communication port (none of which is illustrated), and so forth besides the CPU. As illustrated in FIG. 1, the speed change ECU 21 receives inputs such as the accelerator operation amount Acc from the accelerator pedal position sensor 92, a shift range SR from a shift range sensor 96 that detects the operating position of a shift lever 95 for selecting a desired shift range from a plurality of shift ranges, the vehicle speed V from the vehicle speed sensor 97, signals from various sensors such as an input rotational speed sensor 98 that detects an input rotational speed Nin of the automatic transmission 25 (the rotational speed of a turbine runner 23t or an input shaft 26 of the automatic transmission 25) and an output rotational speed sensor 99 that detects an output rotational speed Nout of the automatic transmission 25 (the rotational speed of an output shaft 27), and signals from the engine ECU 14 and the brake ECU 16. The speed change ECU 21 controls the fluid transmission device 23 and the automatic transmission 25, that is, the hydraulic control device 50, on the basis of the received signals.

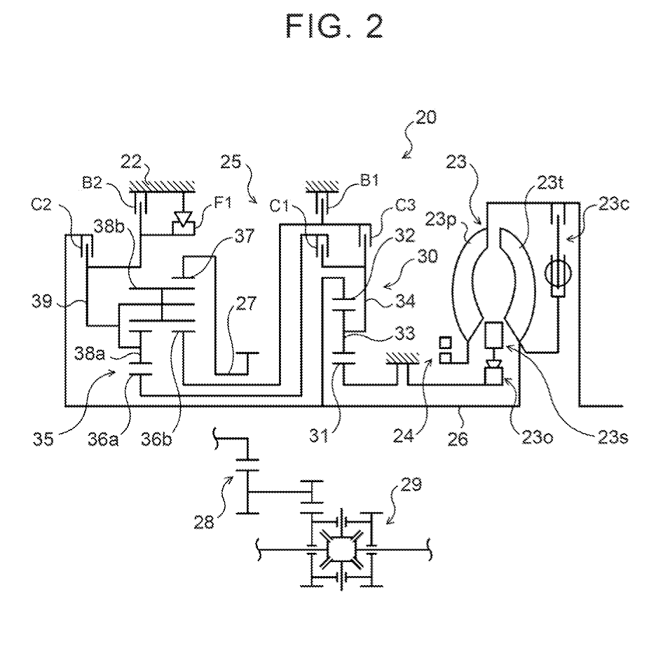

The fluid transmission device 23 of the power transfer device 20 is structured as a torque converter that has a torque amplification function. As illustrated in FIG. 2, the fluid transmission device 23 includes a pump impeller 23p on the input side connected to the crankshaft of the engine 12, the turbine runner 23t on the output side connected to the input shaft (input member) 26 of the automatic transmission 25, a stator 23s disposed on the inner side of the pump impeller 23p and the turbine runner 23t to rectify the flow of working oil (ATF) from the turbine runner 23t to the pump impeller 23p, a one-way clutch 23o that restricts rotation of the stator 23s to one direction, a lock-up clutch 23c, and so forth. An oil pump (mechanical pump) 24 is structured as a gear pump that includes a pump assembly composed of a pump body and a pump cover, an externally toothed gear connected to the pump impeller 23p of the fluid transmission device 23 via a hub, and so forth. When the externally toothed gear is rotated by power from the engine 12, the oil pump 24 suctions working oil reserved in an oil pan (not illustrated) to pump the working oil to the hydraulic control device 50.

The automatic transmission 25 is structured as a 6-speed transmission. As illustrated in FIG. 2, the automatic transmission 25 includes a single-pinion type planetary gear mechanism 30, a Ravigneaux type planetary gear mechanism 35, three clutches C1, C2, and C3, two brakes B1 and B2, and a one-way clutch F1 that change a power transfer path from the input side to the output side, and so forth. The single-pinion type planetary gear mechanism 30 includes a sun gear 31 which is an externally toothed gear held stationary with respect to the transmission case 22, a ring gear 32 which is an internally toothed gear disposed concentrically with the sun gear 31 and connected to the input shaft 26, a plurality of pinion gears 33 meshed with the sun gear 31 and meshed with the ring gear 32, and a carrier 34 that rotatably and revolvably holds the plurality of pinion gears 33.

The Ravigneaux type planetary gear mechanism 35 includes two sun gears 36a and 36b which are each an externally toothed gear, a ring gear 37 which is an internally toothed gear held stationary with respect to the output shaft (output member) 27 of the automatic transmission 25, a plurality of short pinion gears 38a meshed with the sun gear 36a, a plurality of long pinion gears 38b meshed with the sun gear 36b and the plurality of short pinion gears 38a and meshed with the ring gear 37, and a carrier 39 that rotatably and revolvably holds the plurality of short pinion gears 38a and the plurality of long pinion gears 38b, which are coupled to each other, and that is supported by the transmission case 22 via the one-way clutch F1. The output shaft 27 of the automatic transmission 25 is connected to the drive wheels DW via a gear mechanism 28 and a differential mechanism 29.

The clutch C1 is a multi-plate friction-type hydraulic clutch (friction engagement element) that has a hydraulic servo structured from a piston, a plurality of friction plates and mating plates, an oil chamber supplied with working oil, and so forth, and that is capable of fastening and unfastening the carrier 34 of the single-pinion type planetary gear mechanism 30 and the sun gear 36a of the Ravigneaux type planetary gear mechanism 35 to and from each other. The clutch C2 is a multi-plate friction-type hydraulic clutch that has a hydraulic servo structured from a piston, a plurality of friction plates and mating plates, an oil chamber supplied with working oil, and so forth, and that is capable of fastening and unfastening the input shaft 26 and the carrier 39 of the Ravigneaux type planetary gear mechanism 35 to and from each other. The clutch C3 is a multi-plate friction-type hydraulic clutch that has a hydraulic servo structured from a piston, a plurality of friction plates and mating plates, an oil chamber supplied with working oil, and so forth, and that is capable of fastening and unfastening the carrier 34 of the single-pinion type planetary gear mechanism 30 and the sun gear 36b of the Ravigneaux type planetary gear mechanism 35 to and from each other.

The brake B1 is a hydraulic brake that is structured as a band brake or a multi-plate friction-type brake including a hydraulic servo, and that is capable of making the sun gear 36b of the Ravigneaux type planetary gear mechanism 35 stationary and movable with respect to the transmission case 22. The brake B2 is a hydraulic brake that is structured as a band brake or a multi-plate friction-type brake including a hydraulic servo, and that is capable of making the carrier 39 of the Ravigneaux type planetary gear mechanism 35 stationary and movable with respect to the transmission case 22. In addition, the one-way clutch F1 includes an inner race, an outer race, a plurality of sprags, and so forth, for example. The one-way clutch F1 transfers torque via the sprags when the outer race rotates in one direction with respect to the inner race, and allows the inner race and the outer race to rotate with respect to each other when the outer race rotates in the other direction with respect to the inner race. It should be noted, however, that the one-way clutch F1 may be of a roller type or the like, rather than the sprag type.

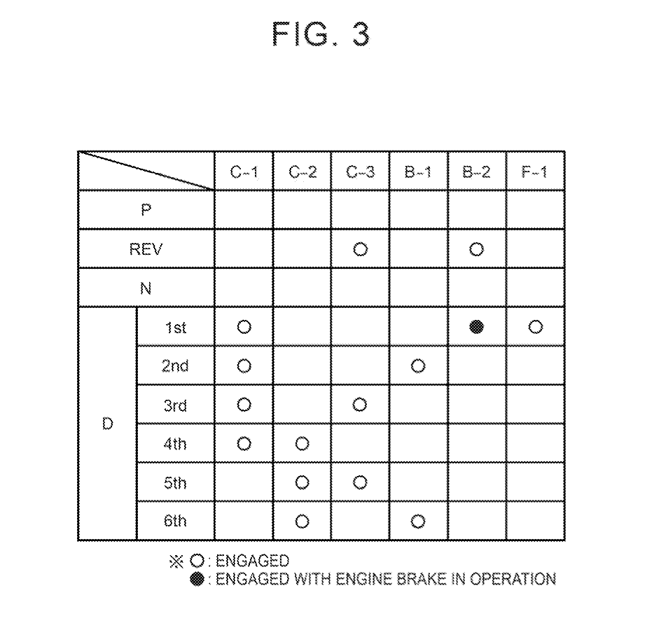

The clutches C1 to C3 and the brakes B1 and B2 operate with working oil supplied thereto and discharged therefrom by the hydraulic control device 50. FIG. 3 is an operation table illustrating the relationship between each shift speed of the automatic transmission 25 and the respective operating states of the clutches C1 to C3 and the brakes B1 and B2. The automatic transmission 25 provides first to sixth forward speeds and a reverse speed when the clutches C1 to C3 and the brakes B1 and B2 are brought into respective states illustrated in the operation table of FIG. 3. As illustrated in FIG. 3, the first speed of the automatic transmission 25 is established by engaging the one-way clutch F1 with the clutch C1 engaged, and the second to fourth speeds are established by engaging the clutch C1 and engaging one of the brake B1 and the clutches C2 and C3. In addition, the fifth and sixth speeds of the automatic transmission 25 are established by engaging the clutch C2 and engaging one of the clutch C3 and the brake B1. At least one of the clutches C1 to C3 and the brakes B1 and B2 may be a meshing engagement element such as a dog clutch.

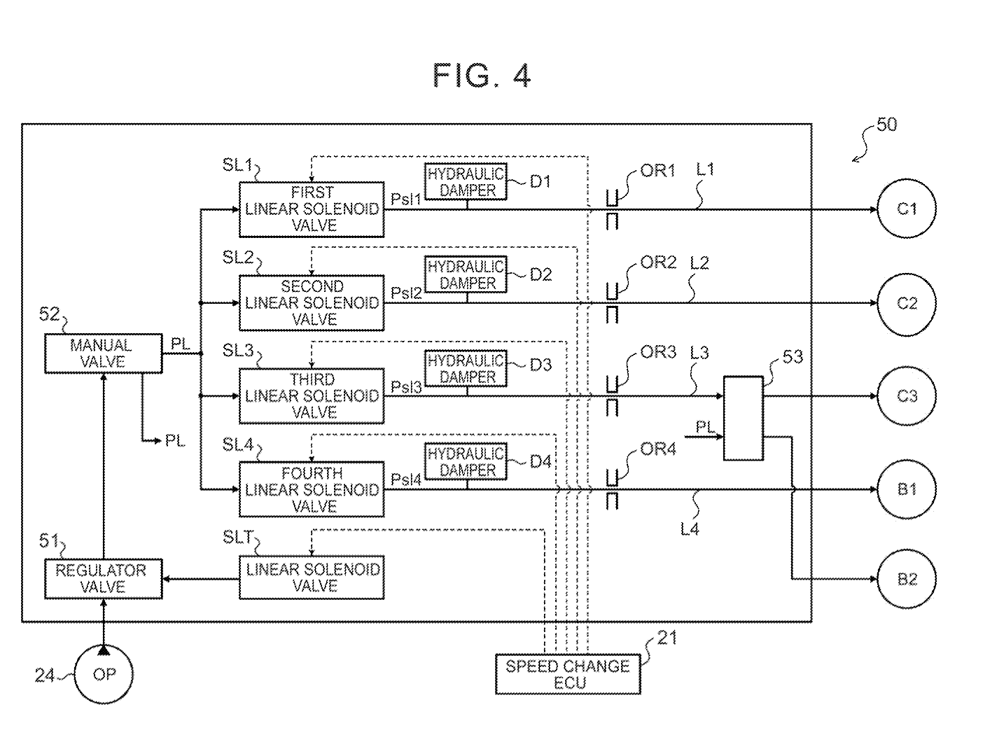

FIG. 4 is a system diagram illustrating the hydraulic control device 50. FIG. 5 is a system diagram of a part of the hydraulic control device 50. The hydraulic control device 50 is connected to the oil pump 24 discussed above which is driven by power from the engine 12 to suction working oil from the oil pan to discharge the working oil, and generates a hydraulic pressure required for the fluid transmission device 23 and the automatic transmission 25 and supplies the working oil to portions to be lubricated such as various bearings. As illustrated in FIG. 4, the hydraulic control device 50 includes: a primary regulator valve 51 that regulates the pressure of working oil from a valve body (not illustrated) or the oil pump 24 to generate a line pressure PL; a manual valve 52 that switches the supply destination of the line pressure PL from the primary regulator valve 51 in accordance with the operating position of the shift lever 95; an application control valve 53; a first linear solenoid valve SL1, a second linear solenoid valve SL2, a third linear solenoid valve SL3, and a fourth linear solenoid valve SL4 that serve as pressure regulation valves that regulate the line pressure PL as a source pressure supplied from the manual valve 52 or the like (primary regulator valve 51) to generate a hydraulic pressure for the corresponding clutches etc., respectively; first to fourth hydraulic dampers D1 to D4 that communicate with (connected to) oil passages L1 to L4, respectively, that communicate between the first to fourth linear solenoid valves SL1 to SL4 and the clutches C1 to C3 and the brakes B1 and B2; and so forth.

The primary regulator valve 51 is driven by a hydraulic pressure from a linear solenoid valve SLT controlled by the speed change ECU 21 so as to regulate the pressure of working oil from the oil pump 24 side (for example, a modulator valve that regulates the line pressure PL to output a constant hydraulic pressure) in accordance with the accelerator operation amount Acc or the opening of the throttle valve (not illustrated). The manual valve 52 has a spool that is axially slidable in conjunction with the shift lever 95, an input port to which the line pressure PL is supplied, a drive range output port that communicates with respective input ports of the first to fourth linear solenoid valves SL1 to SL4 via an oil passage, a reverse range output port, and so forth (none of which is illustrated). When the driver selects a forward travel shift range such as a drive range or a sport range, the line pressure (drive range pressure) PL from the primary regulator valve 51 is supplied to the first to fourth linear solenoid valves SL1 to SL4 as a source pressure via the drive range output port of the manual valve 52. When the driver selects a reverse range, meanwhile, the spool of the manual valve 52 allows the input port to communicate with only the reverse range output port. When the driver selects a parking range or a neutral range, communication between the input port of the manual valve 52 and the drive range output port and the reverse range output port is blocked.

The application control valve 53 is a spool valve that is capable of selectively establishing: a first state in which a hydraulic pressure from the third linear solenoid valve SL3 is supplied to the clutch C3; a second state in which the line pressure PL from the primary regulator valve 51 is supplied to the clutch C3 and the line pressure PL (reverse range pressure) from the reverse range output port of the manual valve 52 is supplied to the brake B2; a third state in which the line pressure PL (reverse range pressure) from the reverse range output port of the manual valve 52 is supplied to the clutch C3 and the brake B2; and a fourth state in which a hydraulic pressure from the third linear solenoid valve SL3 is supplied to the brake B2.

The first linear solenoid valve SL1 is a normally closed linear solenoid valve that can regulate the line pressure PL from the manual valve 52 in accordance with an applied current to generate a hydraulic pressure Psl1 to be supplied to an engagement oil chamber of the clutch C1 via the oil passage L1. The second linear solenoid valve SL2 is a normally closed linear solenoid valve that can regulate the line pressure PL from the manual valve 52 in accordance with an applied current to generate a hydraulic pressure Psl2 to be supplied to an engagement oil chamber of the clutch C2 via the oil passage L2. The third linear solenoid valve SL3 is a normally closed linear solenoid valve that can regulate the line pressure PL from the manual valve 52 in accordance with an applied current to generate a hydraulic pressure Psl3 to be supplied to an engagement oil chamber of the clutch C3 or an engagement oil chamber of the brake B2 via the oil passage L3. The fourth linear solenoid valve SL4 is a normally closed linear solenoid valve that can regulate the line pressure PL from the manual valve 52 in accordance with an applied current to generate a hydraulic pressure Psl4 to be supplied to an engagement oil chamber of the brake B1 via the oil passage L4. Hydraulic pressures for the engagement oil chambers of the clutches C1 to C3 and the brakes B1 and B2 which are friction engagement elements of the automatic transmission 25 are directly controlled (set) by the corresponding first, second, third, and fourth linear solenoid valve valves SL1, SL2, SL3, and SL4.

As illustrated in FIG. 5, the first linear solenoid valve SL1 includes: a generally cylindrical sleeve 62; a spool 64 which is a shaft-like member to be inserted into the sleeve 62; a liner solenoid (electromagnetic portion) 66 that moves the spool 64 leftward in FIG. 5 in the axial direction; and a spring (not illustrated) that urges the spool 64 rightward in FIG. 5 in the axial direction. The sleeve 62 includes: an input port 72 to which working oil is input; an output port 74 that discharges the input working oil, either after being regulated or without being regulated, to the oil passage L1; a drain port 76 that drains the working oil; and a feedback port 78 for inputting the working oil discharged from the output port 74 to a feedback chamber 77 via the oil passage L1 to cause a feedback force to act on the spool 64. The first linear solenoid valve SL1 discharges a larger amount of working oil from the output port 74 (makes the hydraulic pressure higher) as the stroke amount (amount of movement toward the left in FIG. 5) of the spool 64 is larger. The second to fourth linear solenoid valves SL2 to SL4 are configured to be similar to the first linear solenoid valve SL1.

As illustrated in FIGS. 4 and 5, the first to fourth hydraulic dampers D1 to D4 communicate with the oil passages L1 to L4, respectively, at a position at which the distance from the first to fourth linear solenoid valves SL1 to SL4 (the output port 74 and the feedback port 78) is shorter than the distance from the engagement oil chambers of the clutches C1 to C3 and the brakes B1 and B2 in the oil passages L1 to L4, and at a position on the side of the first to fourth linear solenoid valves SL1 to SL4 with respect to orifices OR1 to OR4, respectively, that serve as orifice mechanisms that reduce the flow rate of oil. That is, the first to fourth hydraulic dampers D1 to D4 are disposed in proximity to the first to fourth linear solenoid valves SL1 to SL4, respectively, and communicate with the output port 74 and the feedback port 78 not via the orifices OR1 to OR4, respectively. As illustrated in FIG. 5, the first hydraulic damper D1 includes a case 80, a piston 82 disposed inside the case 80, a spring 84 that urges the piston 82, and an oil chamber 86 that is defined by the case 80 and the piston 82 and that communicates with the oil passage L1. The first hydraulic damper D1 absorbs and damps fluctuations (pulsation) of the hydraulic pressure Psl1 supplied from the first linear solenoid valve SL1 to the clutch C1 with the piston 82 moving in the up-down direction in FIG. 5 (to fluctuate the volume of the oil chamber 86) in accordance with the fluctuations (pulsation) of the hydraulic pressure Psl1. The second to fourth hydraulic dampers D2 to D4 are configured to be similar to the first hydraulic damper D1.

The first to fourth linear solenoid valves SL1 to SL4 discussed above (respective currents applied thereto) are controlled by the speed change ECU 21. That is, when a change between shift speeds is performed, that is, when an upshift or a downshift is performed, the speed change ECU 21 sets a hydraulic pressure command value (engagement pressure command value) for one of the first to fourth linear solenoid valves SL1 to SL4 corresponding to a clutch or a brake (engagement-side element) to be engaged along with a change between shift speeds such that a target shift speed corresponding to the accelerator operation amount Acc (or the opening of the throttle valve) and the vehicle speed V acquired from a speed change line diagram (not illustrated) determined in advance is established. In addition, when a change between shift speeds is changed, that is, an upshift or a downshift is performed, the speed change ECU 21 sets a hydraulic pressure command value (disengagement pressure command value) for one of the first to fourth linear solenoid valves SL1 to SL4 corresponding to a clutch or a brake (disengagement-side element) to be disengaged along with the change between shift speeds. Further, during a change between shift speeds or after completion of shifting, the speed change ECU 21 sets a hydraulic pressure command value (holding pressure command value) for one or two of the first to fourth linear solenoid valves SL1 to SL4 corresponding to a clutch or a brake (engagement-side element) being engaged. Then, the speed change ECU 21 controls a drive circuit (not illustrated) that sets currents to the first to fourth linear solenoid valves SL1 to SL4 on the basis of the set hydraulic pressure command values.

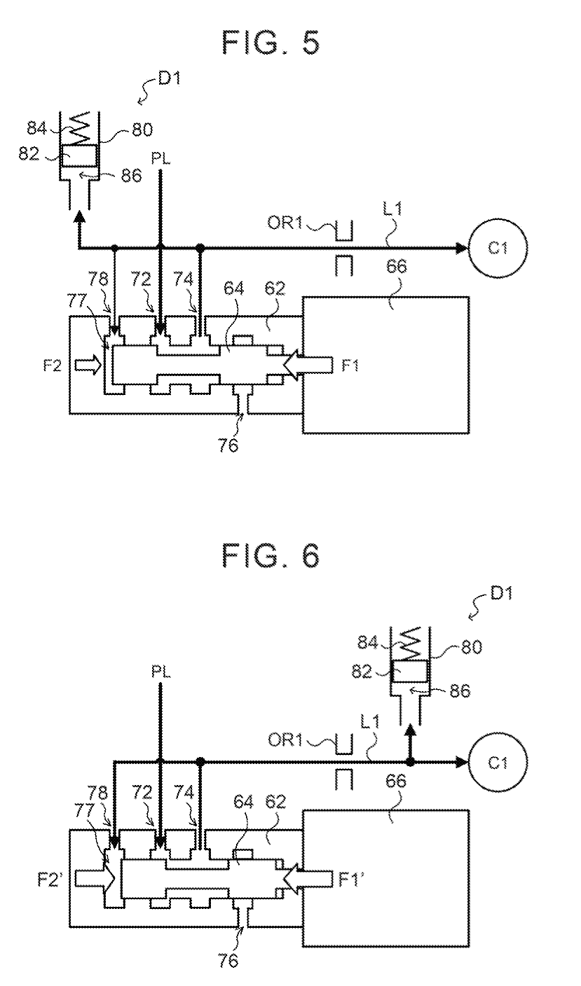

FIG. 6 is a system diagram of a part of a hydraulic control device 50 according to a comparative example. Here, a configuration in which the first hydraulic damper D1 is connected to the oil passage L1 on the side of the clutch C1 with respect to the orifice OR1 is considered as a comparative example. The configuration according to the comparative example is the same as the configuration according to the embodiment except for the position of connection of the first hydraulic damper D1 to the oil passage L1. In FIGS. 5 and 6, “F1” and “F1′” indicate the leftward urging force applied by the liner solenoid 66, and “F2” and “FT” indicate the rightward urging force applied by the spring (not illustrated) and working oil in the feedback chamber 77. Here, components (the liner solenoid valve SL1, the oil passage L1, the first hydraulic damper D1, and the orifice OR1) corresponding to the clutch C1 are described as a part of the hydraulic control device 50. However, the same applies to other components corresponding to the clutches C2 and C3 and the brakes B1 and B2.

First, in the configuration according to the comparative example of FIG. 6, fluctuations (pulsation) of the hydraulic pressure Psl1 to be supplied from the first linear solenoid valve SL1 to the clutch C1 are damped by the hydraulic damper D1 on the side of the clutch C1 with respect to the orifice OR1. Thus, an increased amount of working oil flows to the feedback chamber 77 via the feedback port 78 of the first linear solenoid valve SL1, which raises the hydraulic pressure in the feedback chamber 77. Thus, in order to increase the discharge amount from the output port 74 of the first linear solenoid valve SL1 for the purpose of enhancing the output response of the liner solenoid valve SL1 at the time when the clutch C1 is brought from the disengaged state to the engaged state, it is conceivable to increase the diameter of the sleeve 62 and the spool 64 of the first linear solenoid valve SL1, or to increase the stroke amount of the spool 64. In such a case, however, it is necessary to make the first linear solenoid valve SL1 larger in physical size. In the configuration according to the embodiment of FIG. 5, on the other hand, fluctuations (pulsation) of the hydraulic pressure Psl1 to be supplied from the first linear solenoid valve SL1 to the clutch C1 are damped by the hydraulic damper D1 on the side of the output port 74 and the feedback port 78 with respect to the orifice OR1. Thus, a rise or pulsation of the hydraulic pressure in the feedback chamber 77 is suppressed by the first hydraulic damper D1, which makes the stroke amount of the spool 64 for a hydraulic pressure command value larger than that according to the comparative example for the same hydraulic pressure command value. Consequently, the discharge amount of working oil from the output port 74 is increased, which improves the output response of the first linear solenoid valve SL1 without making the first linear solenoid valve SL1 larger in physical size. As a result, the following effects are obtained when the clutch C1 is used as an engagement-side element during a change between shift speeds.

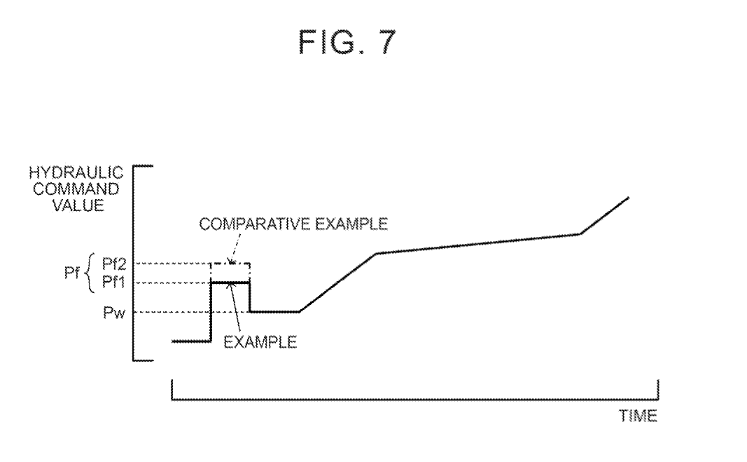

FIG. 7 illustrates an example of temporal variations in a hydraulic pressure command value for the first linear solenoid valve SL1 at the time when the clutch C1 is brought from the disengaged state to the engaged state. In the drawing, the solid line indicates the hydraulic pressure command value for the first linear solenoid valve SL1 according to the embodiment, and the broken line indicates the hydraulic pressure command value for the first linear solenoid valve SL1 according to the comparative example. When the clutch C1 is brought from the disengaged state to the engaged state, as illustrated in the drawing, fast fill is executed using a hydraulic pressure command value Pf, then low-pressure stand-by is executed using a hydraulic pressure command value Pw, then well-known torque phase control or inertia phase control is executed, and finally terminal control in which the hydraulic pressure is maximized is executed. In the embodiment, as discussed above, the output response of the first linear solenoid valve SL1 can be improved compared to the comparative example. Thus, in the case where the duration of the fast fill is set to the same for the embodiment and the comparative example, the hydraulic pressure command value Pf for the fast fill in the embodiment can be set to a value Pf1, which is smaller than a value Pf2 for the comparative example. Consequently, the difference between the hydraulic pressure command value Pf for the fast fill and the hydraulic pressure command value Pw for the low-pressure stand-by can be reduced, which stabilizes the behavior of the hydraulic pressure. That is, the controllability of the liner solenoid valve SL1 can be improved.

In the configuration according to the embodiment, in addition, fluctuations (pulsation) of the hydraulic pressure Psl1 to be supplied from the first linear solenoid valve SL1 to the clutch C1 are damped by the hydraulic damper D1 on the side of the output port 74 and the feedback port 78 with respect to the orifice OR1. Thus, fluctuations (pulsation) of the hydraulic pressure Psl1 to be supplied from the first linear solenoid valve SL1 to the clutch C1 (pulsation of the amount of oil (hydraulic pressure) in the output port 74 and the feedback port 78) can be suppressed compared to the configuration according to the comparative example. That is, the resistance to pulsation can be improved. As a result, it is possible to make the first hydraulic damper D1 smaller in size and make the stroke amount of the spool 64 smaller, which improves the mountability onto the vehicle or the like. In the configuration according to the embodiment, moreover, the hydraulic damper D1 is disposed in proximity to the output port 74 and the feedback port 78. Thus, fluctuations (pulsation) of the hydraulic pressure Psl1 to be supplied from the first linear solenoid valve SL1 to the clutch C1 can be effectively suppressed.

In the hydraulic control device 50 according to the embodiment described above, the first to fourth hydraulic dampers D1 to D4 communicate with the output port 74 of the first to fourth linear solenoid valves SL1 to SL4 not via an orifice mechanism such as the orifices OR1 to OR4, respectively. Thus, fluctuations (pulsation) of the hydraulic pressures Psl1 to Psl4 to be supplied from the first to fourth linear solenoid valves SL1 to SL4 to the clutches C1 to C3 and the brakes B1 and B2 can be suppressed. Moreover, the first to fourth hydraulic dampers D1 to D4 communicate with not only the output port 74 of the first to fourth linear solenoid valves SL1 to SL4 but also the feedback port 78 not via an orifice mechanism such as the orifices OR1 to OR4, respectively. Thus, the output response and the controllability of the first to fourth linear solenoid valves SL1 to SL4 can be improved.

In the hydraulic control device 50 according to the embodiment, the first to fourth hydraulic dampers D1 to D4 communicate with the output port 74 and the feedback port 76 of the first to fourth linear solenoid valves SL1 to SL4 not via the orifices OR1 to OR4, respectively. However, it is only necessary that the first to fourth hydraulic dampers D1 to D4 should communicate with the output port 74 of the first to fourth linear solenoid valves SL1 to SL4 not via the orifices OR1 to OR4, respectively, and an orifice (that is different from the orifices OR1 to OR4) may be disposed between the first to fourth hydraulic dampers D1 to D4 and the feedback port 78 of the first to fourth linear solenoid valves SL1 to SL4.

In the hydraulic control device 50 according to the embodiment, the first to fourth hydraulic dampers D1 to D4 are disposed in proximity to the first to fourth linear solenoid valves SL1 to SL4 (output port 74) (communicate with the oil passages L1 to L4 such that the distance from the first to fourth hydraulic dampers D1 to D4 to the first to fourth linear solenoid valves SL1 to SL4 is shorter than the distance from the first to fourth hydraulic dampers D1 to D4 to the clutches C1 to C3 and the brakes B1 and B2 in the oil passages L1 to L4). However, the first to fourth hydraulic dampers D1 to D4 may not be disposed in proximity to the first to fourth linear solenoid valves SL1 to SL4. Also in this case, pulsation of the hydraulic pressures Psl1 to Psl4 output from the first to fourth linear solenoid valves SL1 to SL4, respectively, can be effectively suppressed since the first to fourth hydraulic dampers D1 to D4 communicate with the first to fourth linear solenoid valves SL1 to SL4 not via the orifices OR1 to OR4, respectively, compared to a configuration in which the first to fourth hydraulic dampers D1 to D4 communicate with the first to fourth linear solenoid valves SL1 to SL4 via the orifices OR1 to OR4, respectively.

In the hydraulic control device 50 according to the embodiment, the first to fourth linear solenoid valves SL1 to SL4 each include the input port 72, the output port 74, the drain port 76, and the feedback port 78. However, the first to fourth linear solenoid valves SL1 to SL4 may not each include the feedback port 78.

The correspondence between the main elements of the embodiment and the main elements of the disclosure described in the “SUMMARY” section will be described. In the embodiment, the clutches C1 to C3 and the brakes B1 and B2 correspond to the “hydraulic engagement element”. The first to fourth linear solenoid valves SL1 to SL4 correspond to the “solenoid valve”. The first to fourth hydraulic dampers D1 to D4 correspond to the “hydraulic damper”.

The correspondence between the main elements of the embodiment and the main elements of the disclosure described in the “SUMMARY” section does not limit the elements of the disclosure described in the “SUMMARY” section, because such correspondence is an example given for the purpose of specifically describing the disclosure described in the “SUMMARY” section. That is, the disclosure described in the “SUMMARY” section should be construed on the basis of the description in that section, and the embodiment is merely a specific example of the disclosure described in the “SUMMARY” section.

While a mode for carrying out the present disclosure has been described above by way of an embodiment, it is a matter of course that the present disclosure is not limited to the embodiment in any way, and that the present disclosure may be implemented in various forms without departing from the scope and sprit of the present disclosure.

### INDUSTRIAL APPLICABILITY

The present disclosure is applicable to the hydraulic control device manufacturing industry and so forth.

1. A hydraulic control device that controls an engagement hydraulic pressure to be supplied to a hydraulic engagement element, comprising:
a solenoid valve that includes an input port, an output port that communicates with the hydraulic engagement element via an oil passage, and a feedback port that communicates with the output port via the oil passage, the solenoid valve regulating a pressure of working oil input from the input port to output the regulated pressure from the output port to the oil passage, a part of the output working oil being input to the feedback port; and
a hydraulic damper that damps pulsation of the hydraulic pressure output from the output port to the oil passage, wherein:
the oil passage is provided with an orifice mechanism that reduces a flow rate of the working oil; and
the hydraulic damper communicates with the oil passage on a side of the output port and the feedback port with respect to the orifice mechanism.

2. The hydraulic control device according to claim 1, wherein
the hydraulic damper communicates with the oil passage such that a distance from the hydraulic damper to the output port and the feedback port is shorter than a distance from the hydraulic damper to a hydraulic pressure chamber for engagement and disengagement of the hydraulic engagement element.
